(19) United States
(12) Patent Application Publication
(10) Pub. No.: US 2025/0333146 A1
(43) Pub. Date: Oct. 30, 2025

(54) AUTOMATED WATERCRAFT OPERATING SYSTEM AND METHOD

(71) Applicant: YAMAHA HATSUDOKI KABUSHIKI KAISHA, Iwata-shi (JP)

(72) Inventors: Hiroshi INOUE, Shizuoka (JP); Daisuke OKAMURA, Shizuoka (JP); Katsutoshi NAITO, Shizuoka (JP); Kunihiko AKAHANE, Shizuoka (JP); Hiroaki TAKASE, Shizuoka (JP); Kazumichi YOSHIDA, Shizuoka (JP); Tomohiro HIROTA, Shizuoka (JP)

(21) Appl. No.: 19/188,352

(22) Filed: Apr. 24, 2025

(30) Foreign Application Priority Data
Apr. 25, 2024 (JP) 2024-071401

(51) Int. Cl. B63B 43/18; B63B 35/00; B63H 25/04; G05D 1/611; G05D 1/622; G05D 1/65; G05D 109/30

(52) U.S. Cl. CPC B63B 43/18; B63B 35/00; B63H 25/04; G05D 1/611; G05D 1/622; G05D 1/65; B63B 2035/007; G05D 2109/34

(57) ABSTRACT

An automated watercraft operating system includes a watercraft operating controller and an obstacle sensor. The watercraft operating controller is disposed in a watercraft and is configured or programmed to control a marine propulsion device. The obstacle sensor is configured to detect an obstacle in the surroundings of the watercraft. When the watercraft operating controller determines that a shift state of the marine propulsion device is not switchable, the watercraft operating controller is configured or programmed to stop driving a driver in the marine propulsion device in accordance with a result of detection by the obstacle sensor.

### CROSS REFERENCE TO RELATED APPLICATIONS

This application claims the benefit of priority to Japanese Patent Application No. 2024-071401 filed on Apr. 25, 2024. The entire contents of this application are hereby incorporated herein by reference.

### BACKGROUND OF THE INVENTION

### 1. Field of the Invention

The present invention relates to automated watercraft operating systems and methods therefor.

### 2. Description of the Related Art

Japan Laid-open Patent Application Publication No. S61-163409 discloses a technology regarding automatically operating a watercraft.

When a marine propulsion device installed in a watercraft breaks down, for instance, it is demanded for an automated watercraft operating system, by which the watercraft is automatically operated in an unmanned manner, to appropriately manage the breakdown of the marine propulsion device in the watercraft.

### SUMMARY OF THE INVENTION

Example embodiments of the present invention provide automated watercraft operating systems and methods therefor, by which, when a marine propulsion device in a watercraft breaks down, the breakdown of the marine propulsion device can be appropriately managed in the watercraft.

According to an example embodiment of the present invention, an automated watercraft operating system for a watercraft including a marine propulsion device including a driver includes a controller and an obstacle detector. The controller is disposed in the watercraft and is configured or programmed to control the marine propulsion device. The obstacle detector is configured to detect an obstacle in surroundings of the watercraft. The controller is configured or programmed to stop driving the driver in accordance with a result of detection by the obstacle detector when it is determined by the controller that a shift state of the marine propulsion device is not switchable.

In the automated watercraft operating system described above, when the shift mechanism to switch the shift state of the marine propulsion device breaks down or becomes stuck, for instance, the driver is stopped being driven in accordance with the result of detection by the obstacle detector. Accordingly, when the shift mechanism of the marine propulsion device installed in the watercraft breaks down, the breakdown of the shift mechanism can be appropriately managed in the watercraft.

According to an example embodiment of the present invention, an automated watercraft operating system for a watercraft including a marine propulsion device including an internal combustion engine includes a controller, a throttle sensor, and an actuator. The controller is disposed in the watercraft and configured or programmed to control the marine propulsion device. The throttle sensor is configured to detect an opening degree of an electronic throttle valve of the internal combustion engine. The actuator is configured to regulate the opening degree of the electronic throttle valve of the internal combustion engine in accordance with a control signal transmitted thereto from the controller. The controller is configured or programmed to limit a velocity of the watercraft when it is determined by the controller that the opening degree of the electronic throttle valve detected by the throttle sensor is greater than the opening degree of the electronic throttle value corresponding to the control signal.

In the automated watercraft operating system described above, the controller is configured or programmed to limit the velocity of the watercraft when the opening degree of the electronic throttle valve is not regulatable to the opening degree corresponding to the control signal transmitted to the actuator from the controller. Accordingly, when the actuator breaks down, for instance, the breakdown of the actuator can be appropriately managed in the watercraft.

According to an example embodiment of the present invention, a method of automatically operating a watercraft including a marine propulsion device including a driver includes detecting an obstacle in surroundings of the watercraft and stopping driving the driver based on a result of detection of the object when it is determined that a shift state of the marine propulsion device is not switchable and that the object does not exist in the surroundings of the watercraft.

According to an example embodiment of the present invention, a method of automatically operating a watercraft including a marine propulsion device including an internal combustion engine includes detecting an opening degree of an electronic throttle valve of the internal combustion engine, regulating the opening degree of the electronic throttle valve of the internal combustion engine in accordance with a control signal, and limiting a velocity of the watercraft when it is determined that the detected opening degree of the electronic throttle valve is greater than the opening degree of the electronic throttle valve corresponding to the control signal.

Overall, according to example embodiments of the present invention, it is possible to provide automated watercraft operating systems and methods therefor, by which, when a marine propulsion device installed in a watercraft is broken, the breakdown of the marine propulsion device can be appropriately managed in the watercraft.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a functional block diagram of an automated watercraft operating system according to an example embodiment of the present invention.

FIG. 2 is a diagram schematically showing navigation routes for a watercraft.

FIG. 3 is a flowchart showing a series of processes to be executed by a watercraft operating controller.

FIG. 4 is a flowchart showing a series of processes to be executed by the watercraft operating controller.

### DETAILED DESCRIPTION OF THE EXAMPLE EMBODIMENTS

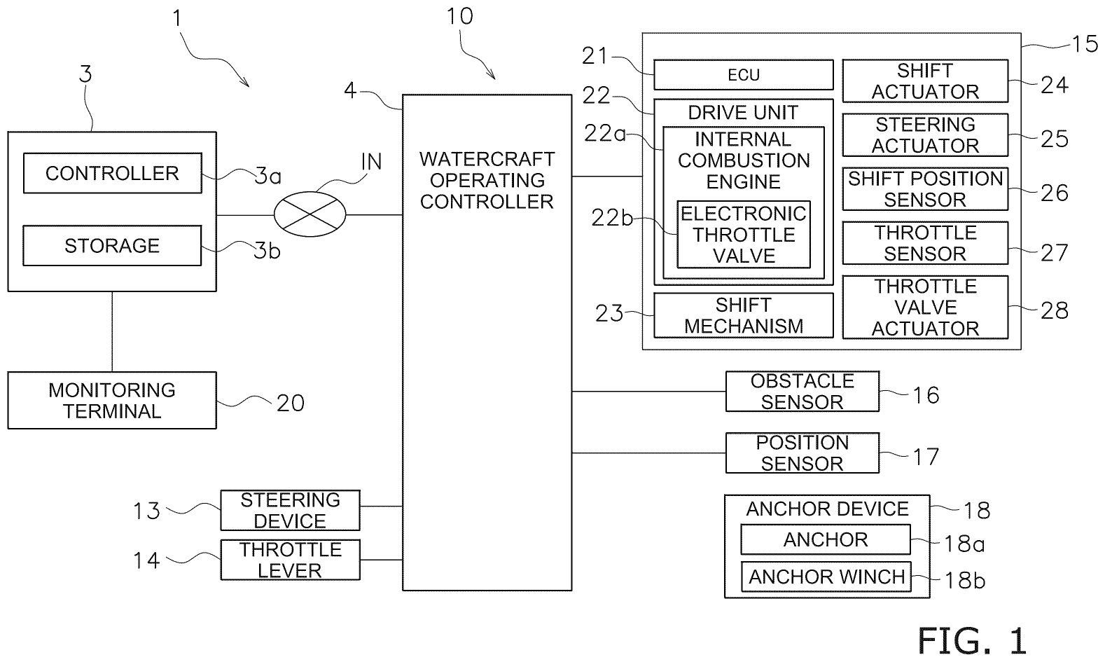

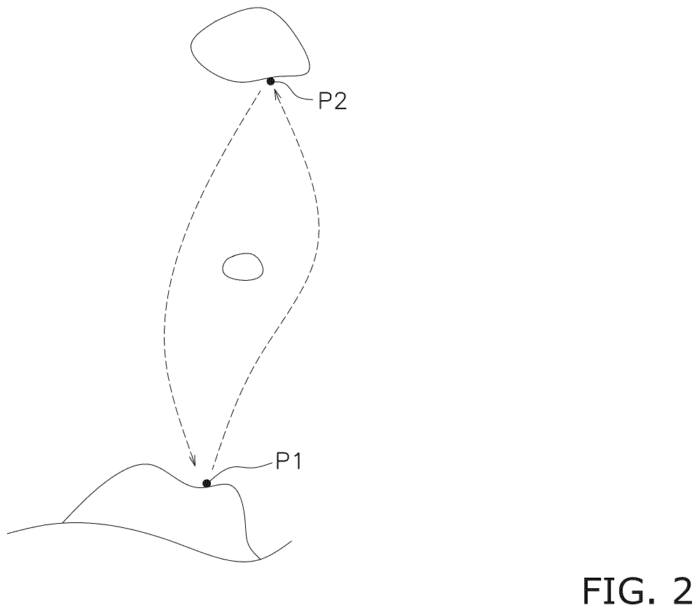

Example embodiments of the present invention will be hereinafter explained with reference to drawings. FIG. 1 is a functional block diagram of an automated watercraft operating system 1. The automated watercraft operating system 1 automatically operates a watercraft 10. FIG. 2 is a diagram schematically showing navigation routes for the watercraft 10. As shown in FIG. 2, the automated watercraft operating system 1 is used for, e.g., automatically operating the watercraft 10 in a round-trip navigation between a first port P1 and a second port P2 remote from the first port P1.

The watercraft 10 is an unmanned watercraft, for instance, and is used to transport only supplies such as food and fuel. The distance from the first port P1 to the second port P2 is, for instance, 50 km. The second port P2 is located at, for instance, a remote island.

The automated watercraft operating system 1 includes a server 3 and a watercraft operating controller 4 (exemplary controller). The server 3 is used as, for instance, a computer to manage the watercraft 10. The server 3 is connected to a monitoring terminal 20 to monitor the watercraft 10 in a communicable manner. The server 3 and the monitoring terminal 20 are connected to be communicable with each other through a network such as the Internet. The server 3 is disposed on the ground. It should be noted that the server 3 may be disposed on the watercraft 10. The monitoring terminal 20 may be a communication terminal such as a smartphone or tablet.

The server 3 includes a controller 3a and a storage 3b. The controller 3a includes a processor such as a CPU (Central Processing Unit) and memories such as a RAM (Random Access Memory) and a ROM (Read Only Memory). The controller 3a is configured to be communicable with the watercraft operating controller 4 through a network such as the Internet.

The storage 3b stores a variety of information and a variety of programs. The storage 3b includes, for instance, recording media/medium such as an HDD (Hard Disk Drive) and/or an SSD (Solid State Drive). The storage 3b stores information regarding the positions of the first and second ports P1 and P2, information regarding a nautical chart in the surroundings of the first and second ports P1 and P2, and so forth. The storage 3b stores at least one route from the first port P1 to the second port P2 and at least one route from the second port P2 to the first port P1. The storage 3b stores values of the target velocity set for the watercraft 10 depending on the routes. It should be noted that the route from the first port P1 to the second port P2 and that from the second port P2 to the first port P1 may be identical to each other. The storage 3b may be included in the controller 3a or the watercraft operating controller 4.

As shown in FIG. 2, the watercraft 10 includes a steering device 13, a throttle lever 14, a marine propulsion device 15, an obstacle sensor 16 (exemplary obstacle detector), a position sensor 17, and an anchor device 18. The watercraft 10 also includes a variety of devices required for automatically operating the watercraft 10 (not shown in the drawings) such as a velocity sensor, an acceleration sensor, a compass sensor, a sonar, and a camera.

The steering device 13 turns the direction of the watercraft 10. The throttle lever 14 regulates the magnitude of a thrust generated by the marine propulsion device 15 and switches the orientations of the thrust between fore and aft directions. The throttle lever 14 also functions as a manual operator to regulate the magnitude of a propulsion force (thrust) for the watercraft 10.

The marine propulsion device 15 includes an ECU (Electronic Control Unit) 21, a driver 22, a shift mechanism 23, a shift actuator 24, a steering actuator 25, a shift position sensor 26, a throttle sensor 27, and a throttle valve actuator 28.

The ECU 21 includes a processor such as a CPU and memories such as a RAM and a ROM. The ECU 21 stores programs and data to control the marine propulsion device 15. The ECU 21 controls the driver 22. The driver 22 generates the propulsion force (thrust) to propel the watercraft 10. The driver 22 includes an internal combustion engine 22a. The driver 22 may include an electric motor.

The shift mechanism 23 changes the rotational direction of a mechanical power transmitted from the driver 22 to a propeller shaft (not shown in the drawings) between a forward moving direction and a rearward moving direction in accordance with an operation on the throttle lever 14.

The shift actuator 24 moves a dog clutch (not shown in the drawings) in accordance with the operation on the throttle lever 14 such that a shift state of the shift mechanism 23 (forward moving state, rearward moving state, and neutral state) is switched from one shift state to another shift state. The steering actuator 25 changes the rudder angle of the marine propulsion device 15 in accordance with the operation on the steering device 13.

The shift position sensor 26 detects the position of the dog clutch in the shift mechanism 23 to detect the shift state of the shift mechanism 23. The throttle sensor 27 detects the opening degree of an electronic throttle valve 22b of the internal combustion engine 22a and outputs the detected opening degree to the watercraft operating controller 4.

The throttle valve actuator 28 regulates the opening degree of the electronic throttle valve 22b of the internal combustion engine 22a in accordance with a control signal transmitted thereto from the watercraft operating controller 4. The throttle valve actuator 28 regulates the opening degree of the electronic throttle valve 22b of the internal combustion engine 22a in accordance with the operation on the throttle lever 14.

The obstacle sensor 16 detects an obstacle in the surroundings of the watercraft 10 and outputs information regarding the obstacle to the watercraft operating controller 4. The obstacle sensor 16 may be, for instance, a LiDAR (Light Detection and Ranging), a RADAR (Radio Detecting and Ranging), a millimeter wave radar, or so forth.

The position sensor 17 may be, for instance, a GPS (Global Positioning System) receiver. The position sensor 17 obtains information regarding the position of the watercraft 10 from a GPS satellite. The position sensor 17 is connected to the watercraft operating controller 4 in a communicable manner. The watercraft operating controller 4 obtains the position of the watercraft 10 from a signal outputted thereto from the position sensor 17.

The anchor device 18 is controlled by the watercraft operating controller 4. The anchor device 18 controls anchoring of the watercraft 10. The anchor device 18 includes an anchor 18a and an anchor winch 18b. The anchor winch 18b lowers or raises the anchor 18a in accordance with a control signal outputted thereto from the watercraft operating controller 4.

The watercraft operating controller 4 is disposed in the watercraft 10. The watercraft operating controller 4 is configured or programmed to control the watercraft 10. The watercraft operating controller 4 includes a processor such as a CPU and memories such as a RAM and a ROM. The watercraft operating controller 4 stores programs and data to control the marine propulsion device 15. The watercraft operating controller 4 is connected to the steering device 13, the throttle lever 14, and the marine propulsion device 15 by wired or wireless communication. The watercraft operating controller 4 controls the shift actuator 24, the steering actuator 25, and the throttle valve actuator 28 through the ECU 21. The watercraft operating controller 4 controls the steering device 13 and the throttle lever 14 through actuators (not shown in the drawings). It should be noted that the watercraft operating controller 4 may control the shift actuator 24 and the throttle valve actuator 28 without intervention of the steering device 13 and the throttle lever 14.

The watercraft operating controller 4 enables the watercraft 10 to navigate to a destination by automatically operating the watercraft 10. The destination herein refers to the first port P1 or the second port P2. The watercraft operating controller 4 causes the watercraft 10 to automatically move from the first port P1 to the second port P2 or vice versa. For example, the watercraft operating controller 4 obtains watercraft operating information required for automatically operating the watercraft 10 in accordance with an operation at the monitoring terminal 20 and causes the watercraft 10 to navigate to the destination by automatically operating the watercraft 10. The watercraft operating information includes, for instance, information regarding the navigation route, the target velocity, the nautical chart, weather, and the destination. The watercraft operating controller 4 transmits, for example, information obtained by a variety of sensors disposed in the watercraft 10 and the image data generated by the camera to the server 3. The watercraft operating controller 4 is configured or programmed to cause the server 3 to display the information obtained by the server 3 from the watercraft operating controller 4, on, for instance, a display of the monitoring terminal 20.

When it is determined that a shift state of the marine propulsion device 15 is not switchable from one to another during automatic operation of the watercraft 10, the watercraft operating controller 4 stops driving the driver 22 in accordance with the result of detection by the obstacle sensor 16.

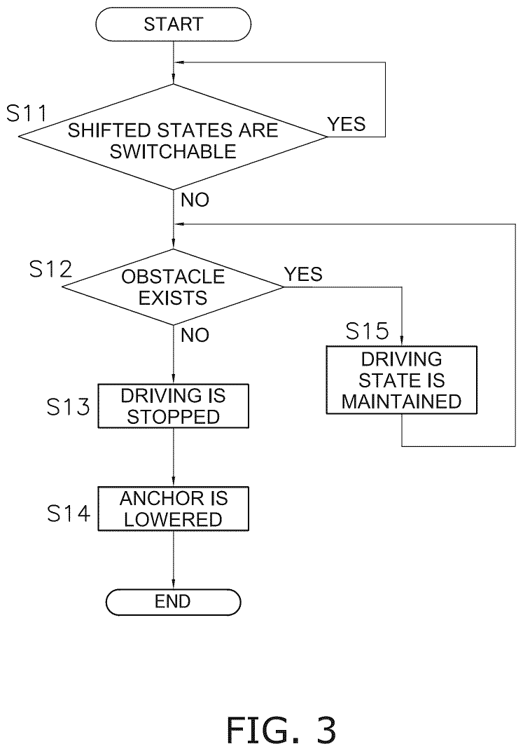

FIG. 3 is a flowchart showing a series of processes to be executed by the watercraft operating controller 4 during the automatic operation of the watercraft 10. In step S11, the watercraft operating controller 4 determines whether or not the shift state of the marine propulsion device 15 is switchable from one to another. For example, the watercraft operating controller 4 determines whether or not the shift state of the shift mechanism 23 has been set in accordance with an operation on the throttle lever 14 based on the result of detection by the shift position sensor 26.

In step S11, the watercraft operating controller 4 may determine whether or not the shift state of the marine propulsion device 15 is switchable from one to another by switching the shift state of the marine propulsion device 15 from a shifted-in state to a neutral state on a regular basis. The shifted-in state of the marine propulsion device corresponds to either the forward moving state or the rearward moving state of the shift mechanism 23. Specifically, the watercraft operating controller 4 may determine whether or not the shift state of the marine propulsion device 15 is switchable from one to another by switching the shift state of the shift mechanism 23 from the forward moving state to the neutral state through the throttle lever 14 on a regular basis (e.g., once a minute).

When the watercraft operating controller 4 determines that the shift state of the marine propulsion device 15 is not switchable from one to another in step S11, the process proceeds to step S12. In step S12, the watercraft operating controller 4 determines whether or not an obstacle exists based on the result of detection by the obstacle sensor 16. This is exemplified as follows. When an obstacle is detected by the obstacle sensor 16 and is located at a close distance (within a predetermined range) from the watercraft 10, the watercraft operating controller 4 determines that the obstacle exists. On the contrary, when an obstacle is detected by the obstacle sensor 16 but is located at a far distance from the watercraft 10, the watercraft operating controller 4 determines that any obstacles do not exist.

When it is determined that any obstacles do not exist in step S12, the watercraft operating controller 4 stops driving the driver 22 (step S13). In other words, the watercraft operating controller 4 stops driving the driver 22 before the watercraft 10 approaches any obstacles. In step S13, for instance, the watercraft operating controller 4 causes the ECU 21 to stop fuel injection and ignition in the internal combustion engine 22a such that the internal combustion engine 22a is stopped being driven.

After stopping driving the driver 22, the watercraft operating controller 4 drives the anchor device 18 to lower the anchor 18a (step S14). In other words, in step S14, the watercraft operating controller 4 anchors the watercraft 10 such that the watercraft 10 is moored within a predetermined range. Then, for instance, the watercraft operating controller 4 causes the server 3 to output an abnormal signal to the monitoring terminal 20.

When it is determined that an obstacle exists in step S12, the watercraft operating controller 4 drives the driver 22 until the watercraft 10 is moved away from the obstacle (step S15). Put differently, in step S15, the watercraft operating controller 4 substantially maintains the driving state of the driver 22 until it is determined that any obstacles do not exist. Thereafter, the watercraft operating controller 4 executes the processes of steps S13 and S14.

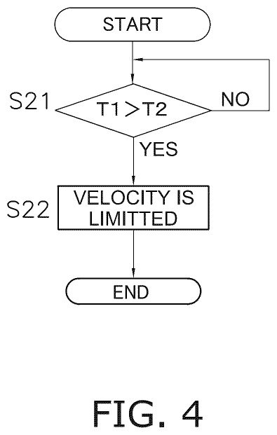

FIG. 4 is a flowchart showing a series of processes to be executed by the watercraft operating controller 4 during the automatic operation of the watercraft 10. In step S21, the watercraft operating controller 4 determines whether or not an opening degree T1 of the electronic throttle valve 22b detected by the throttle sensor 27 is greater than an opening degree T2 of the electronic throttle valve 22b corresponding to the control signal transmitted to the throttle valve actuator 28 from the watercraft operating controller 4. For example, the watercraft operating controller 4 determines whether or not the opening degree T1 of the electronic throttle valve 22b detected by the throttle sensor 27 is greater than an opening degree corresponding to the position of the throttle lever 14.

When it is determined that the opening degree T1 of the electronic throttle valve 22b is greater than the opening degree T2 in step S21, the watercraft operating controller 4 limits the velocity of the watercraft 10 (step S22). For example, the opening degree T1 of the electronic throttle valve 22b becomes greater than the opening degree T2 when the electronic throttle valve 22b becomes uncontrollable due to a breakdown of a motor of the throttle valve actuator 28. When the electronic throttle valve 22b becomes uncontrollable, the opening degree T1 of the electronic throttle valve 22b is configured to become a default opening degree, at which the electronic throttle valve 22b is slightly opened from the fully closed position. At the default opening degree, the rotational speed of the internal combustion engine 22a is 1200 rpm, for instance, and is set to be greater than the idling rotational speed thereof.

In step S22, the watercraft operating controller 4 limits the velocity of the watercraft 10 by alternately switching the shift state of the marine propulsion device 15 between the shifted-in state and the neutral state. In step S22, the watercraft operating controller 4 may limit the velocity of the watercraft 10 by limiting the amount of fuel to be injected into the internal combustion engine 22a. Alternatively, in step S22, the watercraft operating controller 4 may limit the velocity of the watercraft 10 by cutting off ignition in the internal combustion engine 22a. When the ignition in the internal combustion engine 22a is cut off, the velocity of the watercraft 10 may be limited by cutting off ignition in some of the cylinders of the internal combustion engine 22a. When the velocity of the watercraft 10 has already been limited, for instance, the watercraft operating controller 4 may cause the server 3 to output the abnormal signal to the monitoring terminal 20.

In step S21, when limiting the velocity of the watercraft 10, the watercraft operating controller 4 limits the velocity of the watercraft 10 to become a target velocity set in accordance with a target navigation route for the watercraft 10. In other words, in step S21, the watercraft operating controller 4 limits the velocity of the watercraft 10 not to exceed the target velocity set in accordance with the target navigation route for the watercraft 10.

It should be noted that, even when the watercraft operating controller 4 determines that the opening degree of the electronic throttle valve 22b is less than the opening degree corresponding to the control signal in step S21, there is still room for consideration regarding the breakdown of the motor of the throttle valve actuator 28. However, the breakdown of the motor only results in a condition that the velocity of the watercraft 10 becomes less than the target velocity. Thus, it is not required for the watercraft operating controller 4 to limit the velocity of the watercraft 10. When it is determined that the opening degree of the electronic throttle valve 22b is less than the opening degree corresponding to the control signal in step S21, for instance, the watercraft operating controller 4 may cause the server 3 to output the abnormal signal to the monitoring terminal 20.

In the automated watercraft operating system 1 described above, when the shift mechanism 23 for switching the shift state of the marine propulsion device 15 from one to another has become stuck, for instance, the driver 22 is stopped being driven in accordance with the result of detection by the obstacle sensor 16. Accordingly, when the shift mechanism 23 of the marine propulsion device 15 installed in the watercraft 10 breaks down, the breakdown of the shift mechanism 23 can be appropriately managed in the watercraft 10. The watercraft operating controller 4 also limits the velocity of the watercraft 10 when the opening degree of the electronic throttle valve 22b is not regulatable to the opening degree corresponding to the control signal transmitted to the throttle valve actuator 28 from the watercraft operating controller 4. Accordingly, when the motor of the throttle valve actuator 28 breaks down, for instance, the breakdown of the motor can be appropriately managed in the watercraft 10.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An automated watercraft operating system for a watercraft including a marine propulsion device including a driver, the automated watercraft opening system comprising:
a controller disposed in the watercraft and configured or programmed to control the marine propulsion device; and
an obstacle detector configured to detect an obstacle in surroundings of the watercraft; wherein
the controller is configured or programmed to stop driving the driver in accordance with a result of detection by the obstacle detector when the controller determines that a shift state of the marine propulsion device is not switchable.

2. The automated watercraft operating system according to claim 1, wherein the controller is configured or programmed to switch the shift state of the marine propulsion device from a shifted-in state to a neutral state during automated operation of the watercraft.

3. The automated watercraft operating system according to claim 1, wherein the controller is configured or programmed to drive the driver until the watercraft is moved away from the obstacle when it is determined by the controller that the shift state of the marine propulsion device is not switchable from a shifted-in state to a neutral state and that the obstacle exists based on the result of detection by the obstacle detector.

4. The automated watercraft operating system according to claim 1, wherein
the watercraft includes an anchor; and
the controller is configured or programmed to cause the anchor to be lowered after stopping driving the driver.

5. An automated watercraft operating system for a watercraft including a marine propulsion device including an internal combustion engine, the automated watercraft operating system comprising:
a controller disposed in the watercraft and configured or programmed to control the marine propulsion device;
a throttle sensor configured to detect an opening degree of an electronic throttle valve of the internal combustion engine; and
an actuator configured to regulate the opening degree of the electronic throttle valve of the internal combustion engine in accordance with a control signal transmitted thereto from the controller; wherein
the controller is configured or programmed to limit a velocity of the watercraft when it is determined by the controller that the opening degree of the electronic throttle valve detected by the throttle sensor is greater than the opening degree of the electronic throttle valve corresponding to the control signal.

6. The automated watercraft operating system according to claim 5, wherein the controller is configured or programmed to limit the velocity of the watercraft by alternately switching the marine propulsion device between a shifted-in state and a neutral state.

7. The automated watercraft operating system according to claim 5, wherein the controller is configured or programmed to limit the velocity of the watercraft by limiting an amount of fuel to be injected into the internal combustion engine.

8. The automated watercraft operating system according to claim 5, wherein the controller is configured or programmed to limit the velocity of the watercraft by cutting off ignition in the internal combustion engine.

9. The automated watercraft operating system according to claim 5, wherein the controller is configured or programmed to limit the velocity of the watercraft to be a target velocity set in accordance with a target navigation route for the watercraft when limiting the velocity of the watercraft.

10. A method of automatically operating a watercraft including a marine propulsion device including a driver, the method comprising:
detecting an object in surroundings of the watercraft; and
stopping driving of the driver in accordance with a result of detection of the object when it is determined that a shift state of the marine propulsion device is not switchable and that the object does not exist in the surroundings of the watercraft.

11. The method according to claim 10, further comprising:
switching the shift state of the marine propulsion device from a shifted-in state to a neutral state occurs during automated operation of the watercraft.

12. The method according to claim 10, further comprising:
driving the driver until the watercraft is moved away from the object when it is determined that the shift state of the marine propulsion device is not switchable from the shifted-in state to the neutral state and that the object has been detected.

13. The method according to claim 10, wherein the watercraft further includes an anchor, the method further comprising:
lowering the anchor after stopping driving the driver.

14. A method of automatically operating a watercraft including a marine propulsion device including an internal combustion engine, the method comprising:
detecting an opening degree of an electronic throttle valve of the internal combustion engine;
regulating the opening degree of the electronic throttle valve of the internal combustion engine in accordance with a control signal; and
limiting a velocity of the watercraft when it is determined that the detected opening degree of the electronic throttle valve is greater than the opening degree of the electronic throttle valve to correspond to the control signal.

15. The method according to claim 14, further comprising:
limiting the velocity of the watercraft by alternately switching the marine propulsion device between a shifted-in state and a neutral state.

16. The method according to claim 14, further comprising:
limiting the velocity of the watercraft by limiting an amount of fuel to be injected into the internal combustion engine.

17. The method according to claim 14, further comprising:
limiting the velocity of the watercraft by cutting off ignition in the internal combustion engine.

18. The method according to claim 14, further comprising:
limiting the velocity of the watercraft to be a target velocity set in accordance with a target navigation route for the watercraft when the velocity of the watercraft is limited.
